(19) United States
(12) Patent Application Publication
(10) Pub. No.: US 2018/0155942 A1
(43) Pub. Date: Jun. 7, 2018

(54) UNIQUE ARRANGEMENT OF ARCHITECTURAL ELEMENTS

(71) Applicant: Carlton Edward Dewolff, Fairport, NY (US)

(72) Inventor: Carlton Edward Dewolff, Fairport, NY (US)

(21) Appl. No.: 15/673,002

(22) Filed: Aug. 9, 2017

Related U.S. Application Data
(60) Provisional application No. 62/347,993, filed on Jun. 9, 2016.

(51) Int. Cl. E04H 1/00; E04B 1/02; G06Q 10/10

(52) U.S. Cl. CPC E04H 1/005; E04B 2001/0053; G06Q 10/103; E04B 1/02

(57) ABSTRACT

A planning and construction system that embodies methods for uniquely arranging modular architectural elements to construct affordable repetitive buildings based on a cluster-pod-stem configuration is provided. The clusters of prefabricated and/or stick-built modules inherently define a collaborative space share by the cluster as well as a portion of a stem space fluidly communicating to the collaborative space, enabling affordable construction that facilitates a design filled with natural light and less crowded hallways.

### CROSS-REFERENCE TO RELATED APPLICATION

This application claims the benefit of priority of U.S. provisional application No. 62/347,993, filed 9 Jun. 2016, the contents of which are herein incorporated by reference.

### BACKGROUND OF THE INVENTION

The present invention relates to unique arrangement of architectural elements and, more particularly, to a construction system that embodies methods of arranging modular architectural elements to construct affordable, repetitive buildings based on a cluster-pod-stem configuration. Thereby, the method embodied by the modular construction system of the present invention enhances the financial benefit of building affordable living conditions.

A consensus has emerged that there is need to improve living conditions worldwide. A global shortage of affordable housing is one of the root causes of said poor living conditions, as without affordable housing there is no freedom from one's poor environmental situations.

There has been approaches to solve this problem but the minds of the architects have not delved deep enough, and are inhibited with the tradition of profit making in the market place of developers. It is the profit motive and the risk of loss that stymieing developers to utilize new methods to improve the living condition of people in desperate need of functional living housing. There is a need for a new method that diminishes the risk of loss and increases the profitability of affordable, repetitive building construction.

As can be seen, there is a need for employing unique methods of arranging modular architectural elements to construct affordable buildings based on a cluster-pod-stem configuration. The present invention affords such a creative methodology through the unique arrangements of architectural repetitive modules, allowing developers to make more profit through decreasing construction cost. The method of combining several critical architectural elements in new and unique arrangements, additionally, creates the functionality needed to provide better living conditions in tight spaces, while still providing psychological freedom from a user's poor environments.

### SUMMARY OF THE INVENTION

In one aspect of the present invention, a unique method of arranging architectural elements includes providing a plurality of similarly dimensioned modules each defined by an interfacing wall and a plurality of side walls; and interconnecting each said interfacing wall so as to define a collaborative space and a portion of a stem space, wherein the stem space communicates to the collaborative space.

In another aspect of the present invention, the unique method of arranging architectural elements includes providing a plurality of similarly dimensioned modules each defined by an interfacing wall and a plurality of side walls; and interconnecting each said interfacing wall so as to define a collaborative space and a portion of a stem space, wherein the stem space communicates to the collaborative space, wherein only two first modules of the plurality of modules define an extent of two opposing faces of the collaborative space respectively, and wherein the remaining modules of the plurality of modules, each partially define an extent of two other opposing faces of the collaborative space, wherein at least two side walls of each plurality of side walls of said remaining modules are facing orthogonal from the collaborative space, wherein each interfacing wall perpendicularly abuts another interfacing wall, wherein two of said remaining modules abut side walls at a midpoint of one of the two other opposing faces of the collaborative space, wherein another two of said remaining modules have spaced apart side walls equally offset from the midpoint so as to define the stem space, and wherein an arrangement of the plurality of similarly dimensioned modules define a pod-stem configuration.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of a pod and stem arrangement of the present invention;

FIG. 2 is a schematic view of an exemplary embodiment of a pod arrangement incorporating various architectural elements of the present invention;

FIG. 3A is a schematic view of prior art;

FIG. 3B is a schematic view of an exemplary embodiment of the present invention, illustrating increased congregate functionality and the number of classrooms with natural light; and

FIG. 4 is a perspective view of an exemplary embodiment of the present invention, applied to housing/bed units.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a construction system that embodies methods for arranging modular, prefabricated and/or stick-built architectural elements to construct affordable building units based on a cluster-pod-stem configuration. The clusters of stick-built and/or prefabricated modules inherently define a collaborative space shared by the cluster as well as a portion of a stem space fluidly communicating to the collaborative space, enabling affordable construction that facilitates a design filled with natural light and less crowded hallways, while providing a psychological freedom imposed on poor environments. The unique arrangements of architectural elements provide psychological freedom from traditional antiquated and depressing environments in schools, student housing, senior and assisted living, dormitories, immigration housing, third-world housing, and the like. Combined with the proprietary modular housing, the unique arrangement provides a method through which developers can move on from traditional construction and employ prefabricated and/or stick-built modular construction, because of the potential for realizing significant cost savings and profits.

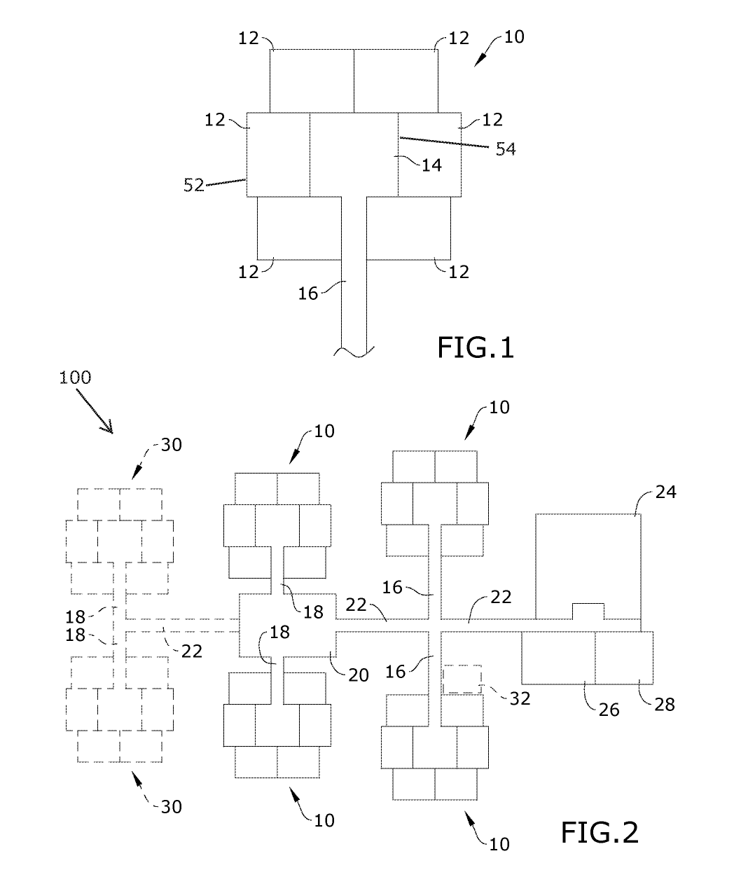

Referring to FIGS. 1 through 4, the present invention may include a prefabricated and/or stick-built modular construction system 100 embodying a method of arranging architectural elements to construct affordable repetitive housing. The modular construction system 100 applies the repetitive use of a certain plan type of prefabricated and/or stick-built module 12 placed in a variety of arrangements relative to each other.

The present invention contemplates prefabricated and/or stick-built modular construction based on pod-stem-cluster arrangement. The cluster 10, 30, 40 is an arrangement of a plurality of modules 12 connected so as to define an internal pod or collaborative space 14, 44 fluidly communicating to a stem space 16, 18, 46. The stem space is the umbilical cord to the clustered modules. Such a template enables affordable planning and construction of structures. In certain embodiments, the stem spaces 16, 18, 46 typically connect to open corridor space 22, 38, 48, and/or interconnect with additional spaces 24, 26, 28, central congregate area 20, common areas 50, and the like. The feasibility of the novel arrangement allows for cost effective construction of schools, student housing, nursing facilities, urgent care, independent live, office complexes, immigration housing, and the like.

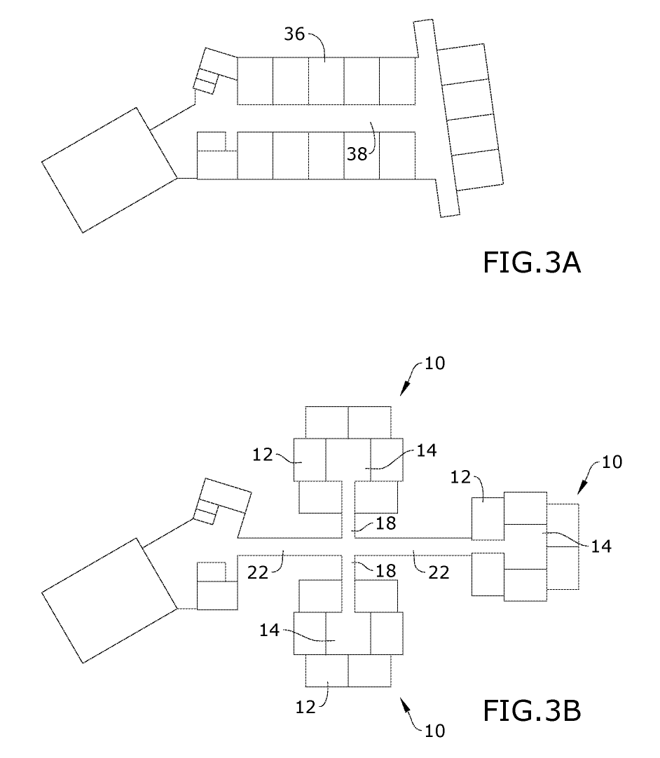

The relationship between each housing module is critical and, depending on access circulation connecting these modules, the overall use of the creative arrangement of these modules 12 can minimize the psychological harm that traditional structures have imposed on the users. For example, traditional school classrooms as illustrated in FIG. 3A, have a linearity, wherein rooms 36 are placed on two sides of a hallway 38, wherein students are being pushed through, in essence, a cattle-run. Moreover, the individual rooms 36 have minimal exposure to natural light. Furthermore, these traditional methods of construction are costly and incur many delays because of shipping problems, labor problems, inclement weather, architectural and engineering uncertainties, and the like. The articulated modular construction system 100 of the present invention, on the other hand, alleviates many of the listed problems, since most of the collaborative space 14 and stems 16 are the byproduct of the clustered modules 12, a builder reaps an approximately 30% reduction of site construction relative to traditional construction, while eliminating the cattle-run feel, and increasing the exposure to natural light to the modules as well as the stems and corridors. As a result, the connecting corridors allows light and views as well as less crowded traditional hallways. There is a very definite feeling of openness and exploratory ambulation for students.

Moreover, each module 12 or 42 may be created with different functions to accommodate different users. These prefabricated and/or stick-built modules may be clustered in such a way that they enhance each other, and the clusters communicate to an access pathway that connects the modular parts into a whole—a microcosm becoming a macrocosm—providing scalable configurations, adaptable to the comfort level of different users. The modular clusters can be built in one story up to 6 stories, or higher.

In a first embodiment, referring to FIGS. 1 and 2, each module 12 may have the same dimensioned plan view, in order to minimize cost by repetition of size and shape. It should be noted, that even though the Figures show plan views, the modules, stems, and collaborative spaces are three dimensional with variable predetermined heights. Each module 12 has four walls 52, wherein one of the four walls 52 is an interfacing wall 54 operatively associating with so as to define the collaborative space 14. It should be noted, that even though the Figures show only generally rectangular prefabricated modules 12, different prefabricated modules 12 may form different shapes as long as they have an interfacing wall 54 and a plurality of side walls to define an interior space of the prefabricated module 12. It also being understood that the interfacing walls 54 have a doorway or other passageway connecting the inside of the prefabricated module 12 to the collaborative space 14. Here, six modules 12 abut the collaborative space 14, wherein two first modules 12 are generally coextensive with two opposing walls of the collaborative space 14, while the remaining four second modules 12 overlap both a portion of the collaborative space 14 and one of the two first modules 12. On one side, two of the four second modules 12 abut to continuously define the collaborative space 14, while the other two of the four second modules are spaced apart to additionally define a portion of the stem 16. The remainder of the stem 16 may be additional walls. Furthermore, the remainder of the stem 16, between the cluster of modules 12 and the corridor space 22, enables future rooms 32 to be installed to accommodate expansion.

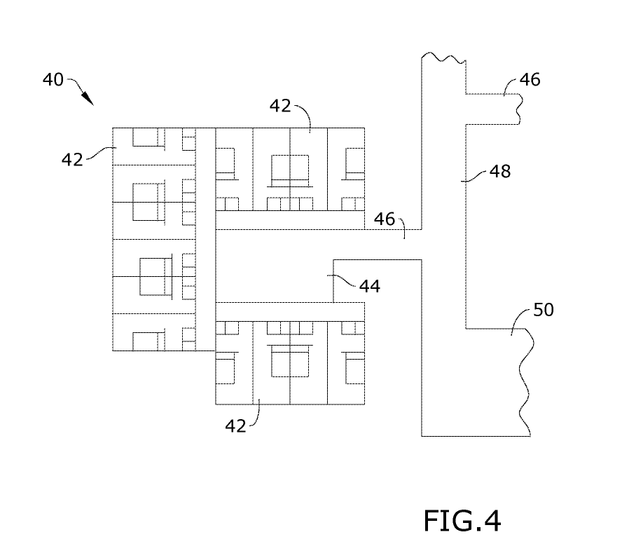

In a second embodiment, referring to FIG. 4, in the context of arranging housing and bed units, the collaborative space 44 may be defined on only three sides, each such side defined by one module 42, and wherein the modules 42 are not similarly dimensioned. The modules 42 may be completely furnished utilizing flexible furniture, utilities, appliances and even medical and manufacturing equipment. For example, the modules 42 of the present invention, as shown in FIG. 4, may house bedrooms for dormitory style living.

A method of using the present invention may include the following. The modular construction system 100 disclosed above may be provided. The financier or developer of construction projects could employ the methods embodied herein to build repetitive structures for increasing the number of modules and thereby saving construction funds and delivering greater profits facilitating bond acquisition and financing. For instance, through the present invention a developer can improve the number of units a builder constructs by 59% and realize a savings of 25% if builders employs modular construction of which he or she can take a 10% profit.

It should be understood, of course, that the foregoing relates to exemplary embodiments of the invention and that modifications may be made without departing from the spirit and scope of the invention as set forth in the following claims.

1. A method of constructing an affordable structure comprising the steps of:
providing a plurality of similarly dimensioned modules each defined by an interfacing wall and a plurality of side walls, and each module dimensioned and adapted to house a plurality of human users; and
interconnecting each said interfacing wall so as to define a collaborative space and a portion of a stem space, wherein the stem space communicates to the collaborative space.

2. The method of claim 1, wherein only two first modules of the plurality of modules define an extent of two opposing faces of the collaborative space respectively, and wherein the remaining modules of the plurality of modules, each partially define an extent of two other opposing faces of the collaborative space.

3. The method of claim 2, wherein at least two side walls of each plurality of side walls of said remaining modules are facing orthogonal from the collaborative space.

4. The method of claim 2, wherein each interfacing wall perpendicularly abuts another interfacing wall.

5. The method of claim 2, wherein two of said remaining modules abut side walls at a midpoint of one of the two other opposing faces of the collaborative space.

6. The method of claim 5, wherein another two of said remaining modules have spaced apart side walls equally offset from the midpoint so as to define the stem space.

7. The method of claim 6, wherein an arrangement of the plurality of similarly dimensioned modules define a pod-stem configuration.

8. The method of claim 7, wherein the plurality of similarly dimensioned modules in each pod-stem configuration consists of six modules.

9. The method of claim 8, wherein each module is prefabricated.

10. A method of constructing an affordable structure comprising the steps of:
providing a plurality of similarly dimensioned modules each defined by an interfacing wall and a plurality of side walls, and each module dimensioned and adapted to house at least one of human user; and
interconnecting each said interfacing wall so as to define a collaborative space and a portion of a stem space, wherein the stem space communicates to the collaborative space,
wherein only two first modules of the plurality of modules define an extent of two opposing faces of the collaborative space respectively, and wherein the remaining modules of the plurality of modules, each partially define an extent of two other opposing faces of the collaborative space,
wherein at least two side walls of each plurality of side walls of said remaining modules are facing orthogonal from the collaborative space,
wherein each interfacing wall perpendicularly abuts another interfacing wall,
wherein two of said remaining modules abut side walls at a midpoint of one of the two other opposing faces of the collaborative space,
wherein another two of said remaining modules have spaced apart side walls equally offset from the midpoint so as to define the stem space, and
wherein an arrangement of the plurality of similarly dimensioned modules define a pod-stem configuration.

11. The method of claim 10, wherein the plurality of similarly dimensioned modules in each pod-stem configuration consists of six modules.

12. The method of claim 10, wherein each module is prefabricated.
